(19) United States
(12) Patent Application Publication
(10) Pub. No.: US 2021/0226189 A1
(43) Pub. Date: Jul. 22, 2021

(54) FIRE PROPAGATION PREVENTION SYSTEM FOR BATTERY MODULES IN A BATTERY PACK

(71) Applicant: NIO USA, Inc., San Jose, CA (US)

(72) Inventors: Marc W. Juzkow, Livermore, CA (US); Shubham Saurav, San Jose, CA (US)

(21) Appl. No.: 16/748,078

(22) Filed: Jan. 21, 2020

(51) Int. Cl. H01M 2/10; H01M 10/052; H01M 10/625; H01M 10/658; H01M 2/12; H01M 10/48; B60L 58/24

(52) U.S. Cl. CPC H01M 2/1094; H01M 10/052; H01M 10/625; H01M 10/658; B60L 2240/545; H01M 10/486; B60L 58/24; H01M 2220/20; H01M 2/12

(57) ABSTRACT

The present disclosure is directed to a barrier wall between battery modules that comprises two or more of a structural element to resist impacts from vented objects during a thermal runaway of a cell, a thermally anisotropic material to transfer heat away from the thermal runaway away from the affected cell, and a fire-resistant material that is not only fire-resistant but also electronically non-conducting or insulating to inhibit electrical shorting between the affected cell and the structural element or thermally anisotropic material.

### FIELD

The present disclosure is generally directed to energy storage devices, in particular, towards batteries with fire propagation prevention systems.

### BACKGROUND

In recent years, the demand for high performance electrochemical cells has increased, driven in part by the increasingly large number of portable consumer electronics products and growing needs of batteries for hybrid and fully electric vehicles.

Lithium battery cells (Li cells) are found in many applications requiring high energy and high-power densities, as they can provide high volumetric and gravimetric efficiency in single and multi-cell battery modules and packs. Such battery packs modules and can be used in many applications, for instance in electric vehicles.

However, multi-cell Li battery modules and packs are susceptible to extreme heat build-up, fire or explosion through a phenomenon known as passive propagation, or thermal diffusion, where one or a small number of cells go into thermal runaway causing the other cells to also go into thermal runaway. Thermal runaway occurs when heat is generated inside a Li cell exceeding the capability of the Li cell to release that heat. There are many scenarios that can create heat inside the Li cell, from an internal short circuit to an external electrical fault. Thermal runaway resembles an uncontrolled positive feedback loop that accelerates the internal temperature of a Li cell (and/or many Li cells) eventually leading to the entire battery pack to vent or be ruptured to emit smoke, sparks, fire, and/or an explosion.

Failure of one Li cell can cause a chain reaction or propagation, where additional cells in a battery pack fail, potentially causing serious circumstances (i.e. an explosion or fire). While the energy released in one cell can most often be contained within a battery pack of an electric vehicle, posing no danger to the driver of an electrical vehicle, the energy released by many or all cells inside an EV battery pack will most likely fill the cabin of the vehicle with smoke at a minimum and/or cause the entire EV to be engulfed in flames. The safety of the driver and passengers, and bystanders is paramount, and they must be protected.

As more and more Li battery packs are used in electric vehicles, a solution to this issue becomes more pressing. The present disclosure satisfies these and other needs.

### SUMMARY

A fire propagation prevention apparatus for a battery pack includes one or more battery modules, the one or more battery modules comprising a plurality of battery cells arranged in a plurality of rows, and each battery cell in the one or more battery modules comprises a vent. The apparatus includes a structural element separating at least two of the battery modules of the plurality of battery modules and a thermally anisotropic material positioned between the structural element and one or more of the at least of the battery modules and in thermal contact with one or more battery cells of the one or more of the at least of the battery modules, wherein the thermally anisotropic material has an in-plane thermal conductivity greater than a through-plane thermal conductivity.

A fire propagation prevention system for an electric vehicle system. The electric vehicle system includes one or more battery modules, wherein the battery module comprises a plurality of battery cells arranged in a plurality of rows and a battery module enclosure for the battery module and each of the battery cells comprises a vent. The fire propagation prevention system includes a structural element which separates at least two battery modules of the at least one or more battery modules and a fire-resistant material, wherein the fire-resistant material is substantially electrically non-conductive and/or insulative and wherein the fire-resistant material is positioned between the structural element and one or more of the at least two battery modules.

A method for fire propagation prevention in a battery pack including one or more battery modules, the one or more battery modules comprising a plurality of battery cells arranged in a plurality of rows, wherein each battery cell in the one or more battery modules comprises a vent, is provided. The method comprises venting, by at least one battery cell of the plurality of battery cells, of thermal energy and transferring, a thermally anisotropic material, heat away from the venting at least one battery cell of the plurality of battery cells.

The embodiments of the present disclosure can advantageously improve the prevention of fire propagation in energy storage devices and provide increased safety for electric vehicle drivers, passengers, and bystanders. The disclosure can be particularly beneficial in a battery pack design having opposing lithium-ion cell modules oriented for maximum energy density. In this design, the headers of cells and the cell events in the headers face each other. Both sides of flat cooling plates can cool simultaneously the bottom surface of the cells in the opposing modules. Using one cooling plate for two layers of cells can substantially minimize the volume and mass of the cooling plates. When a cell vent activates and releases hot gases, electrolyte, components (including the header and electrodes) or flames, the barrier disclosed herein that is positioned between the opposing cell modules can prevent a thermal runaway in one module from propagating to an opposing module. As will be appreciated, a battery pack design should ensure that one cell going into thermal runaway does not propagate to other cells leading to a full battery pack failure. The disclosure can be used for any cell design but particularly for a cylindrical or prismatic lithium-ion cell with a flat surface.

Additional features and advantages are described herein and will be apparent from the following Description and the figures.

### BRIEF DESCRIPTION OF THE DRAWINGS

FIG. 1 shows a schematic perspective view of an electrical energy storage system;

FIG. 2 shows a cross-sectional side view of a header of a battery cell;

FIG. 3A includes a top down interior view of a battery module and a side view of the barrier wall;

FIG. 3B shows a front isometric view of the wall between battery modules; and

FIG. 4 shows a top down view of the fire propagation prevention wall.

### DETAILED DESCRIPTION

The present disclosure is directed to a fire propagation prevention system comprising a multi-layer, multi-functional barrier to prevent a cell undergoing thermal runaway from propagating thermal runaway to other battery cells and/or other modules.

In some embodiments, a structural element is used to provide stiffness/support for a wall or barrier separating two or more battery modules. The use of a structural element can prevent vented projectiles striking the cell(s) opposite a runaway battery cell in a battery pack. If the projectile breaches the wall or structural element, it can cause cells on the opposite side of the barrier to go into thermal runaway.

In some embodiments, the structural element can be any rigid or substantially rigid material having a relatively high impact resistance. Examples include materials imparting stiffness to the barrier such as metals, metal alloys (e.g., steel and aluminum alloys), ceramics, engineered plastics, and composite materials, such as fiber-based composites (e.g., combinations of glass fiber or carbon fibers with a toughened epoxy resin) and ceramic-coated structures. Because the battery pack will typically be in a hybrid or electric vehicle, lighter-weight materials can provide higher levels of energy efficiency.

In some embodiments, an additional layer of a thermally anisotropic material can be added to the fire propagation prevention system, which may be placed over and/or on-top-of one or both sides of the structural element. In embodiments where the thermally anisotropic material layer is present, it can be adhered to the wall with an adhesive layer on the graphite foil or alternatively through a lamination process. Typically, the thermally anisotropic material layer is meant to substantially minimize heat transfer from a venting cell on one side of the barrier to a cell or module opposite the barrier.

In some embodiments, the thermally anisotropic material may include (e.g., in the form of a sheet, foil, or other planar or non-planar substrate), such as eGRAF® SpreaderShield™ made of pure graphite foil, positioned in spatial proximity to cell vents and/or thermal sensors positioned in operational contact to the thermally anisotropic material that together can sense rapidly and effectively an unusual thermal emission from one or more cells. The thermally anisotropic material is typically dimensionally and crystallographically stable at the high temperatures commonly encountered in a thermal runaway event (e.g., typically at temperatures of at least about 1,500 but typically no more than about 2,000 degrees Fahrenheit). Stated differently, the thermally anisotropic material is free of a phase change material that changes phase within this temperature range.

In cylindrical and prismatic cells, one or more devices are typically designed into the cell to allow venting of excess pressure and prevent rupturing of the can, violent removal of the cell header, and expulsion of cell components. The vents typically direct the heat released from the cell in one direction. Placement of a thermally anisotropic material (such as a sheet of graphite foil) thermally connected to the cell vents can “capture and absorb” the heat evolved. Graphite anisotropic materials in particular can have a much higher thermal conductivity in a first direction or plane than in a second direction or plane. Substantially pure graphite anisotropic materials, for instance, can conduct heat 400× better in the x-y direction than in the z direction. One graphite anisotropic material, for example, has thermal conductivity values of at least about 50, more commonly of at least about 100, more commonly of at least about 150, more commonly of at least about 200, more commonly of at least about 250, more commonly of at least about 300, more commonly of at least about 350, and even more commonly of at least about 400 W/m-K in an in-plane orientation but less than about 50, more commonly no more than about 40, more commonly no more than about 35, more commonly no more than about 30, more commonly no more than about 25, more commonly no more than about 20, more commonly no more than about 15, more commonly no more than about 10, and even more commonly no more than about only 5 W/m-K in a through-plane orientation. This not only can prevent the heat from reaching the cells opposite the cell vents possibly resulting in thermal runaway of those cells but can also transfer the heat away from the vented cells and its adjacent cells. Some embodiments of the present disclosure can take advantage of this phenomenon by measuring the temperature of the thermally anisotropic material in one or two (for redundancy or proximity) points.

In some embodiments, multiple light/photo sensors connected to the module electronics are strategically positioned relative to the anisotropic material to catch the light (IF) emitted from the thermal runaway. These light sensors can pick up any burning activities inside the battery pack even faster than temperature sensors. Additionally, the fire propagation prevention apparatus of this disclosure can be used in combination with other types of sensors for redundancy and to avoid false positives. As will be appreciated, other types of sensors can be employed to sense thermal events.

Embodiments of the present disclosure can be applied to any electrochemical device, particularly large battery packs or modules. There are generally three types of lithium-ion cells typically used in EVs today: namely cylindrical, pouch and prismatic. Individual cells can be arranged in any pattern within a battery module, with a common pattern resembling a honeycomb or matrix. Embodiments of the present disclosure can apply to all larger battery packs (or modules) comprised of any of the three cell types, even 1 kWh or higher, in many different applications ranging from electric bicycles and small scooters to commercial vehicles, industrial vehicles, and trains to large energy storage systems with hundreds of thousands to millions of Wh of energy. Thermal events with large cells can be easier to detect due to the large amount of energy released when compared to thermal events in smaller cylindrical cells.

In some embodiments, the fire propagation prevention system includes a third layer of a non-electrically conductive fire-resistant material on one or both sides of the structural element. Typically, the non-electrically conductive fire-resistant material acts as a fire barrier that is meant to block fire and flames from penetrating the wall, however another property of this film is its non-conductivity. If the non-electrically conductive fire-resistant material or cells is dislodged during a thermal event, the non-electrically conductive fire-resistant material will not short-circuit the lithium-ion cells as would, for example a conductive fire resistant material (if placed over the thermally anisotropic material).

In some embodiments, while the fire-resistant layer is duplicative of the anisotropic material in blocking fire and flames from penetrating to the structural element, the layer provides the added advantage of being substantially electrically non-conductive or insulative to prevent electrical shorting between the tops of the cells against the structural element or anisotropic material. The fire-resistant layer typically has thickness of at least about 0.25 mils and more typically of at least about 0.50 mills and typically no more than about 100 mils and more typically no more than about 50 mils; a glow wire ignition temperature (GWIT) typically of at least about 650° C. and more typically of at least about 750° C. but typically no more than about 2,750° C. and more typically no more than about 2,500° C.; and a glow wire flammability index (GWIT) typically of at least about 625° C. and more typically of at least about 725° C. but typically no more than about 2,750° C. and more typically no more than about 2,500° C. While any material having these properties can be used, an exemplary material is a material sold by 3M under the tradename Flame Barrier FRB.

In some embodiments, the various layers in the fire propagation prevention system can prevent thermal runaway propagation by providing a type of fire propagation prevention barrier wall. In some embodiments, the fire propagation prevention barrier positions the thermal anisotropic material between the structural element and the third fire-resistant layer. In some embodiments, the fire propagation prevention barrier omits the thermal anisotropic material and contacts the structural element directly with the third fire-resistant layer. In some embodiments, there may be a physical air gap between the fire propagation prevention wall and the opposing cells to reduce temperature transfer, thus reducing the risk of the opposing cells from experiencing a thermal runaway condition. The physical air gap can act as an additional insulative layer which helps to prevent thermal runaway propagation.

In other embodiments, the fire propagation prevention wall could be used for a module case, for example the module wall for pouch cells that can vent in multiple directions. Placing pouch cells inside a case made from the fire propagation prevention wall would prevent flames or high temperature reaching other modules. The fire propagation prevention wall could also be used as a case for other types of lithium-ion cells, including prismatic and cylindrical cells.

The fire propagation prevention wall can be used in a wide variety of battery pack module configurations. A particularly beneficial configuration orients the battery cells substantially flat or horizontal. Orienting the battery cells flat or horizontally rather than vertically can increase the amount of battery cells that may be placed in a battery module, thus increasing battery module gravimetric density. However, more tightly packing a battery module with battery cells can increase risks associated with thermal runaway, in instances where thermal runaway occurs heat may more easily spread to adjacent battery cells. The increased risks can make using a horizontal battery cell orientation have heretofore made this orientation less attractive. A horizontal battery cell orientation may be particularly attractive in situations where small and more compact battery cells are used for a similar pack enclosure. If smaller more compact battery cells were to be vertically orientated there could be a large empty volume which would reduce the total battery cells to be packed, however if the battery cells are placed in a horizontal configuration, they can take up the full height and volume of the pack.

Although embodiments described herein may be described with respect to a battery module with a horizontal battery cell orientation, the present disclosure is not so limited. Various embodiments of the present disclosure can apply to more traditional vertical battery cell orientations.

Although embodiments described herein may be described with respect to a ground based electric vehicle, the present disclosure is not so limited. Various embodiments of the present disclosure can apply to any type of stationary or mobile machine using a battery, for example mobile machines including but not limited to, vertical takeoff and landing vehicles, aircraft, spacecraft, electrical grids, and watercraft, among others.

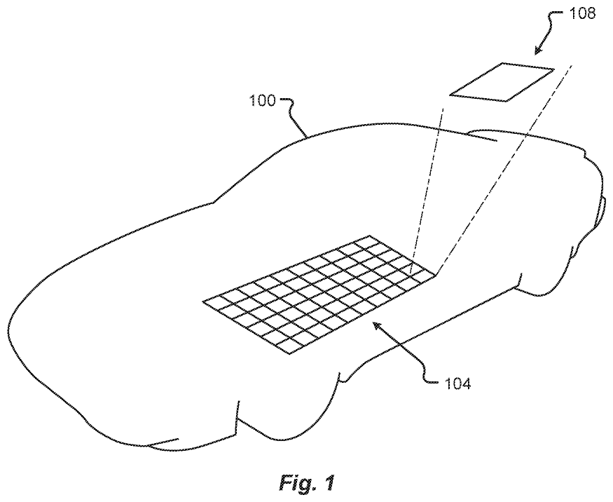

Referring now to FIG. 1, a schematic perspective view of an electrical energy storage system, or battery pack 104 comprising a number of electrical energy storage devices, or battery modules 108, is shown in accordance with embodiments of the present disclosure. In one embodiment, the battery pack 104 may be configured to provide the electromotive force needed for the electrical drive system of a vehicle 100 to operate. An electrical energy storage device for a vehicle generally includes one or more battery packs 104 including a number of battery modules electrically interconnected with one another to provide the electromotive force for the electrical drive system of a vehicle to operate. Each battery module in the battery can include any number of battery cells contained and/or arranged within a structure. Conventional battery modules may include a structure or components that are designed to maximize the number of battery cells contained therein. Although the present disclosure recites battery pack 104, battery modules 108, and/or battery cells as examples of electrical energy storage units, embodiments of the disclosure should not be so limited. For example, the battery cells 308, and/or any other energy storage device disclosed herein, may be any electrical energy storage cell including, but in no way limited to, battery cells, electrochemical double layer capacitors, etc., and/or combinations thereof.

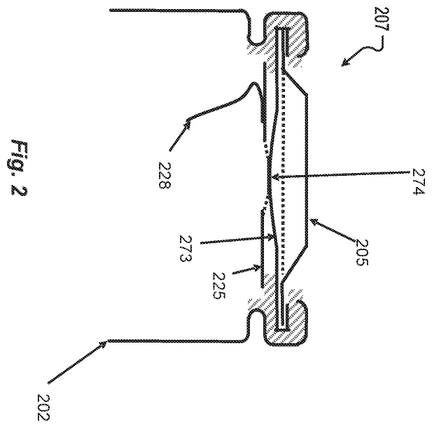

FIG. 2 shows a cross-sectional side view of a header 207 of a battery cell 308. A gasket insulator (not shown) is used as a seal between the can 202 and the header 207.

In FIG. 2, the header 207 includes a negative electrode tab 228 (e.g., an end portion of the negative electrode) that is connected to a weld disc 225, a vent disc 273 and a top cap 205. The connection 274 from the weld disc 225 to the vent disc 273 may be made by welding. The vent disc 273 is pressed against the top cap 205, thereby providing an electrical connection from the negative electrode tab 228 to the top cap 205. In some embodiments, a Positive Temperature Coefficient (“PTC”) device shaped like a flat ring is positioned between the vent disc 273 and the top cap 205, but this is not typical for applications requiring high drain rates. Thus, the top cap 205 is the cover of the cell and the negative terminal of the cell. In some embodiments the top cap 205 is not used and the electrical connection is made directly to the vent disc 273.

In the event of thermal runaway in the can 202, the resulting internal pressure within the can causes the vent disc 273 to be displaced upwardly to dislodge the top cap 205, thereby discharging thermal runaway-generated gas from the interior to the exterior of the cell 207. While the cell of FIG. 2 is shown to vent at the top cap 205, it is to be understood that other cell designs have a second vent at the bottom of the cell adjacent to the cold plate (not shown) or another selected location on the can, however in both the horizontal cell and vertical cell design, a bottom vent is in thermal contact with cold plate 340 and as a result, the vent is blocked, forcing the top vent to operate.

In some embodiments, the header 207 has been crimped onto the can 202 so that the interior components of the battery cell are fully enclosed within the can 202 and the header 207. The interior of the battery cell includes a positive electrode (connected to a positive electrode tab 228), a negative electrode (not shown), separators (not shown), and an electrolyte (not shown). The positive electrode can include a positive electrode active material and a positive electrode current collector having a conductive coating. The negative electrode can include a negative electrode active material and a negative electrode current collector having a conductive coating. The electrolyte may be present within the positive electrode, the negative electrode, and the separators, and may include a lithium compound such that the electrolyte, the positive electrode, and the negative electrode are in ionically conductive contact with each other.

During charging of the cell, risks of cell overcharging, overheating or short circuiting is typically at the highest. In such a scenario, thermal runaway is a possibility, and the heat generated from the damage to one or more cells may spread to other cells, causing additional problems, such as increased cell failure and dangerous conditions. Also, if a cell header 207 is expelled, this may damage other battery cells within the battery module 108 and lead to other issues such as increased cell failure and dangerous conditions for the battery pack 104. The runaway of a single battery cell 308 runaway can lead to many runaways in many battery cells 308, so early detection is important to warn of the situation and possibly prevent thermal runaway in other battery cells 308.

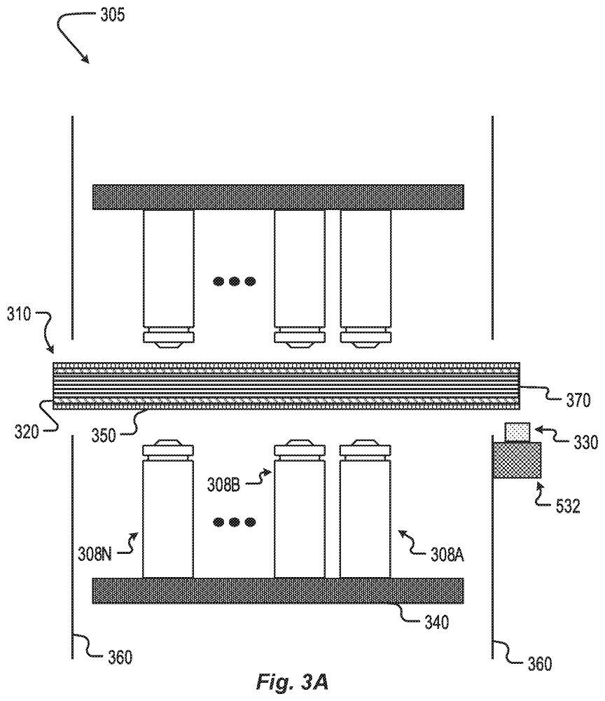

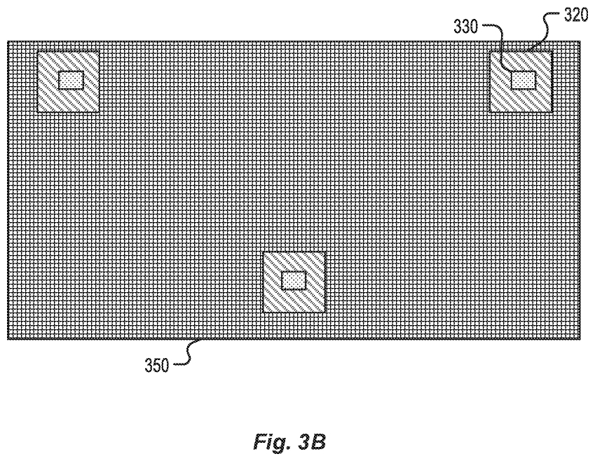

FIG. 3A shows a top-down view of the thermal incident detection system 305 in accordance with embodiments of the present disclosure. The top-down view includes a wall 310 that is disposed between two rows of battery cells 308, where the battery cells 308 positioned proximate to each other and each battery cell 308 has its header 207 towards the wall 310. In the present embodiment, cell headers 207 contain the vents for battery cells 308. One or more spacers (not shown) may be positioned between the wall 310 and the adjacent battery module to maintain a substantially fixed position of each of the modules relative to one another and the wall 310. Additionally, a carrier (not shown) can be engaged with an end of each battery module to maintain each cell in a substantially fixed position relative to one another.

In FIG. 3A, battery cells 308 are aligned horizontally in the battery module 108. In some embodiments, the battery module 108 is split into portions of battery cells 308 where the battery cell headers 207 are facing away from each other. FIG. 3A also shows wall 310 having a thermally anisotropic material 320 fixed to either side of structural element 370. However, in alternative embodiments thermally anisotropic material 320 may be fixed to only one side of structural element 370. FIG. 3A shows sensor 330 and cold plate 340. FIG. 3A also shows two battery modules 108 separated by wall 310 and thermally anisotropic material 320, however this is merely one embodiment, there may be embodiments where wall 310 and thermally anisotropic material 320 are enclosed within one battery module 108. For instance, wall 310 may also include a layer of fire-resistant layer 350 placed over anisotropic material 320.

Wall 310 can, alternatively or additionally, include a variety of other materials that serve different functions. In some embodiments, wall 310 can include a structural element 370 designed to resist puncture. The puncture resistant material can, for example, include steel, porous steel, aluminum, porous aluminum, composites, ceramics, ceramic matrix composites, carbon, expanded carbon, carbon fiber, carbon fiber-reinforced polymers, graphene, mesh, rubber, polymers, elastomers, titanium, nickel, iron, phase change materials, and/or any combination thereof. Any puncture resistant material used for wall 310 may be processed in such a way as to make it lighter, for instance processing aluminum to get porous aluminum. Other types of processing that may occur to a puncture resistant material selected for wall 310 is the addition additives, for instance impregnating graphite with an additive. Additionally, or in the alternative, structural element 370 can include a coating; for instance, structural element 370 may have a dielectric coating.

In some embodiments, wall 310 can include a substantially non-conductive fire-resistant material 350 to enable the wall 310 to act as a fire barrier between the rows of cells. If wall 310 comprises a fire-resistant layer 350 than wall 310 may have high flammability resistance, high arc resistance, and high dielectric strength. For instance, wall 310 may have a non-conductive fire-resistant material that can withstand fires typically ranging from 500° C. to 2000° C. and more typically ranging from about 700° C. to about 1100° C. In some embodiments, the non-conductive fire-resistant material acts as an electrically insulating barrier between an electrically conductive anisotropic layer and the cell can 202 and cell header 207, which can electrically short if they come in contact. The non-conductive fire-resistant material can, for example, include polybenzimidazole fiber, aramids (para and meta), fire-resistant cotton, nylons, coated nylons, polyhydroquinone-diimidazopyridine (PIPD) fiber, melamine, modacrylic, leather, modified leathers, polystyrene, polypropylene, polyphenylene ether, a tetrafluoroethylene-perfluoroalkylvinylether copolymer, polycarbonate, polyphenylene sulfide, polybutylene terephthalate, and/or any combination thereof. Other materials that can be included in wall 310 include 3M® Flame Barrier FRB-NT Series™. In other embodiments, wall 310 can have properties of both a structural element 370 and a substantially non-conductive fire-resistant material 350. For instance, wall 310 can be a puncture resistant non-conductive fire-resistant barrier.

In some embodiments, there may be a structural element 370, an anisotropic material 320, and a fire-resistant layer 350 all layered together as shown in FIG. 3A. In these embodiments, the fire-resistant layer 350 may be covering anisotropic material 320 and anisotropic material 320 may cover structural element 370. It should be appreciated by one skilled in the art, that wall 310 may include only some of these layers or all of the aforementioned layers.

In situations, where thermal runaway occurs or is in the process of occurring, a battery cell vent may expel hot gas, electrolyte, electrodes, etc. The thermally anisotropic material 320 is positioned to be in spatial proximity to the header 207 of venting battery cell 308 such that the heat from the battery cell vent would at least partially transfer to the thermally anisotropic material 320 for early detection by one or more sensors 330. Thermally anisotropic material 320 may be designed to have poor through plane thermal conductivity while having high in-plane thermal conductivity. Thus, thermally anisotropic material 320 can by rapid transfer of thermal energy away from the thermal runaway cell also retard the spread of heat, or thermal energy transfer, to battery cells 308 on the other side of wall 310 and spread the heat, or transfer thermal energy, away from an area where venting is occurring. Rapidly spreading or transferring the heat along thermally anisotropic material 320 can prevent other nearby battery cells 308 from overheating and undergoing thermal runaway.

The in-plane thermal conductivity of thermally anisotropic material 320 may be typically from about 650 W/m-K to about 250 W/m-K, more typically from about 600 W/m-K to about 260 W/m-K, more typically from about 550 W/m-K to about 270 W/m-K, more typically from about 520 W/m-K to about 280 W/m-K, more typically from about 510 W/m-K to about 290 W/m-K, more typically from about 500 W/m-K to about 300 W/m-K, more typically from about 490 W/m-K to about 310 W/m-K, more typically from about 480 W/m-K to about 320 W/m-K, more typically from about 470 W/m-K to about 330 W/m-K, more typically from about 460 W/m-K to about 340 W/m-K, more typically from about 450 W/m-K to about 350 W/m-K, more typically from about 440 W/m-K to about 360 W/m-K, more typically from about 430 W/m-K to about 370 W/m-K, more typically from about 420 W/m-K to about 380 W/m-K, more typically from about 410 W/m-K to about 390 W/m-K, or more typically 400 W/m-K.

The through-plane thermal conductivity of the material(s) may be typically from 2.4 W/m-K to 5.0 W/m-K, more typically from 2.5 W/m-K to 4.9 W/m-K, more typically from 2.6 W/m-K to 4.8 W/m-K, more typically from 2.7 W/m-K to 4.7 W/m-K, more typically from 2.8 W/m-K to 4.6 W/m-K, more typically from 2.9 W/m-K to 4.5 W/m-K, more typically from 3.0 W/m-K to 4.4 W/m-K, more typically from 3.1 W/m-K to 4.3 W/m-K, more typically from 3.2 W/m-K to 4.2 W/m-K, more typically from 3.3 W/m-K to 4.1 W/m-K, more typically from 3.4 W/m-K to 4.0 W/m-K, more typically from 3.5 W/m-K to 3.9 W/m-K, more typically from 3.6 W/m-K to 3.8 W/m-K, or more typically 3.7 W/m-K.

In some embodiments, the in-plane thermal conductivity is greater than the through-plane thermal conductivity of the thermally anisotropic material 320, more typically is at least about 50% greater than the through-plane thermal conductivity of the thermally anisotropic material 320, more typically is at least about 100% greater than the through-plane thermal conductivity of the thermally anisotropic material 320, more typically is at least about 200% greater than the through-plane thermal conductivity of the thermally anisotropic material 320, more typically is at least about 300% greater than the through-plane thermal conductivity of the thermally anisotropic material 320, more typically is at least about 400% greater than the through-plane thermal conductivity of the thermally anisotropic material 320, more typically is at least about 500% greater than the through-plane thermal conductivity of the thermally anisotropic material 320, more typically is at least about 600% greater than the through-plane thermal conductivity of the thermally anisotropic material 320, more typically is at least about 700% greater than the through-plane thermal conductivity of the thermally anisotropic material 320, more typically is at least about 800% greater than the through-plane thermal conductivity of the thermally anisotropic material 320, more typically is at least about 900% greater than the through-plane thermal conductivity of the thermally anisotropic material 320, more typically is at least about 1,000% greater than the through-plane thermal conductivity of the thermally anisotropic material 320, and more typically is at least about 1500% greater than the through-plane thermal conductivity of the thermally anisotropic material 320.

In other embodiments it is possible that battery cells 308 are not in two rows but face-up towards an upper shield or lid (not shown) of battery module 108. In these embodiments thermally anisotropic material 320 is fixed to the bottom surface of the upper shield or lid. Thermally anisotropic material 320 can be configured to be in proximity to the header 207 of a venting battery cell 308 such that the heat from the battery cell 308 vent would at least partially transfer to thermally anisotropic material 320 fixed to the upper shield or lid.

FIG. 3B also contains sensors 330 positioned so as to sense a thermal state, or temperature, of the thermally anisotropic material 320 positioned on an adjacent exterior surface of the wall 310. A non-exhaustive list of sensor types could include the following: a luminescence sensor, a temperature sensor (e.g., a thermistor, thermocouple or infrared thermometer), a smoke sensor, a pressure sensor, and/or a wavelength sensor. Sensors 330 may have multiple kinds of sensors housed within a single sensor housing, for example sensor 330 could be both a light and temperature sensor. Multiple types of sensors placed within a single sensor housing may lead to reduced weight, reduced false positives, or both.

Due to the high in-plane thermal conductivity of the thermally anisotropic material 320, sensors 330 can monitor an entire battery module 108 from a few discrete locations. Sensors 330 can be configured to monitor small or large areas within the battery module 108. Sensors 330 can be integrated into (or in communication with) a battery management system 532 (BMS). Sensors 330 can monitor the thermally anisotropic material 320 such that when the thermally anisotropic material 320 heats-up the sensor communicates a warning signal to the BMS 532. Sensors 330 can either be placed intermittently along anisotropic material 320 or in other embodiments, there can be a single sensor placed at either end of wall 310. In some embodiments, sensors 330 can be placed in the battery module 108, or in other places not along anisotropic material 320; for instance, sensor 330 can be placed on an outer wall of battery module enclosure 360. Some embodiments can include a light sensor 330 placed outside the battery module enclosure 360.

FIG. 3B shows a front isometric view of wall 310. In FIG. 3B certain elements have been removed, in order to provide a clear view of the interior of the battery module 108. FIG. 3B shows an embodiment where anisotropic material 320 is placed on over structural element 370. FIG. 3B also shows an embodiment where sensor(s) 330 is placed in operative contact with anisotropic material 320, furthermore this embodiment also shows a fire-resistant layer 350 placed over the anisotropic material 320. Sections of fire-resistant layer 350 were removed so the anisotropic material 320 and sensors below could be revealed. In some embodiments, BMS 532 can be placed on an outside wall of the battery module enclosure 360.

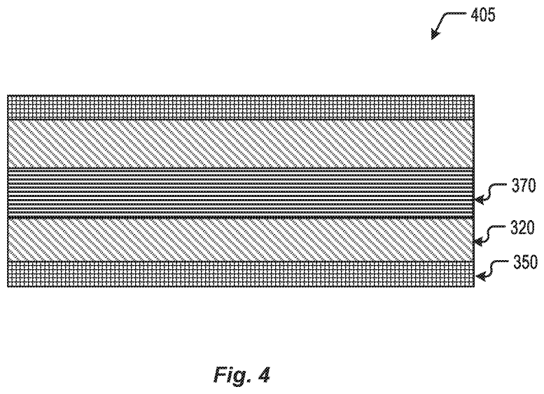

FIG. 4 shows top-down view of the fire propagation prevention wall 405 in accordance with embodiments of the present disclosure. Each layer of the fire propagation prevention wall 405 can be clearly observed. Each layer of the fire propagation prevention wall 405 may be shuffled such that any layer can have any position in the fire propagation prevention wall 405. For instance, structural element 370 may be the outermost layer (not shown) of the fire propagation prevention wall 405, rather than fire-resistant material 350 as shown in FIG. 4.

Fire propagation prevention wall 405 may also have a variety of thicknesses of its various layers. For instance, fire propagation prevention wall 405 can. For instance, fire propagation prevention wall 405 can include one or more layers of the thermally anisotropic material 320 having a thickness typically ranging from about 0.040 to about 2 mm and more typically ranging from about 0.049 to about 1 mm. In embodiments where fire propagation prevention wall 405 has one or more layers of the structural element 370, the structural elements 370 have a thickness typically ranging from about 0.040 to about 0.080 mm and more typically ranging from about 0.049 to about 0.056 mm. In embodiments, where fire propagation prevention wall 405 has one or more layers of the fire-resistant layer 350 with a thickness typically ranging from about 0.075 to 0.4 mm, more typically from about 0.1 to about 0.26 mm, more typically from about 0.1 to about 0.2 mm, and more typically from about 0.125 mm to about 0.15 mm. A total thickness of the fire propagation prevention wall 405 typically ranges from about 1.5 to about 4 mm and more typically ranging from about 1.75 to about 2 mm.

In other embodiments, the fire propagation prevention wall 405 has a different orientation relative to the cells to reflect a different cell vent location. For example, if the battery cell 308 were to vent at the base of the can, fire propagation prevention wall 405 could be located adjacent to the cold plate 340. In the other embodiments, the fire propagation prevention wall 405 is positioned such that it is in spatial proximity to a cell vent location.

Cold plate 340 can be used to separate battery cells 308 within the same battery module 108. For instance, in some embodiments a battery module 108 may house two rows of battery cells 308, where the headers of the two rows of battery cells may be facing away from each other, these two rows of battery cells may also be separated by cold plate 340. Cold plate 340 may be a cooling plate which is in thermal contact with a cooling medium to cool battery cells 308.

### EXPERIMENTAL

The following examples are provided to illustrate certain aspects, embodiments, and configurations of the disclosure and are not to be construed as limitations on the disclosure, as set forth in the appended claims. All parts and percentages are by weight unless otherwise specified.

In a firewall simulation test using a propane torch, both solid and perforated metal sheets were tested as structural elements.

A set of tests using a propane torch to simulate thermal runaway of a cell was performed where the temperature of the torch was similar to the temperature measured during actual cell thermal runaway events (1000˜1100° C.). A variety of laminated samples were tested as follows. Both steel and aluminum metal sheets, perforated and non-perforated. Tests were run with 0, 1 and 2 sheets of graphite foil for comparisons. The torch was run for up to 180 seconds; however, the maximum venting time is <<30 seconds. The temperature was measured directly in the flame next to the barrier and 9 temperatures on the opposite side of the barrier were measured.

The tested structural elements are set forth in Table I below.

| | | | | | |
|---|---|---|---|---|---|
| | Mass | L | W | T | Density |
| Component | (g) | (cm) | (cm) | (cm) | (g/cc) |

Stiffness/Penetration

| | | | | | |
|---|---|---|---|---|---|
| Steel Sheet | 69.6 | 15.4 | 15.2 | 0.042 | 7.08 |
| 26 GA | 67.1 | 15.2 | 15.1 | 0.060 | 4.87 |
| Perforated | | | | | |
| (23% porous) | | | | | |
| 24 GA | 61.2 | 15.3 | 15.3 | 0.055 | 4.75 |
| Perforated | | | | | |
| (37% porous) | | | | | |
| Al Sheet | 32.8 | 15.4 | 15.3 | 0.051 | 2.74 |
| Al Perforated | 11.7 | 15.3 | 15.1 | 0.080 | 0.63 |
| (79% porous) | | | | | |

The tested wall configurations are set forth in Table II below:

| Test | | | Non-Conductive |
|---|---|---|---|
| # | Stiffness/Penetration | Thermal Barrier | Fire Barrier |
| 1 | Steel sheet (0.42 mm) | GF (2 layers) | FRB (2 layers) |
| 2 | Steel sheet (0.42 mm) | GF (1 layer) | FRB (1 layer) |
| 3 | Steel sheet (0.42 mm) | Reflecta-Gold | FRB (1 layer) |
| | | Tape (1 layer) | |
| 4 | Steel sheet (0.42 mm) | None | FRB (1 layer) |
| 5 | Al sheet (0.2 mm) | GF (1 layer) | FRB (1 layer) |
| 6 | 24 GA perforated steel | GF (1 layer) | FRB (1 layer) |
| 7 | 24 GA perforated steel | GF (2 layers) | FRB (2 layers) |
| 8 | Al laminate supplied by | GF (2 layers) | FRB (2 layers) |
| | Marian (0.25 mm Al) | | |
| 9 | Al perforated sheet | GF (2 layers) | FRB (2 layers) |
| | (0.8 mm) | | |
| 10 | 26 GA perforated steel | GF (2 layers) | FRB (2 layers) |

A test summary after 60 seconds shows that the graphite foil spreads the heat very well. The largest temperature range on the measurements on the back side of the torch were for samples without graphite foil, similarly, the highest temperatures recorded on the opposite side of the torch were with 0 layers of graphite foil, followed by 1 layer and 2 layers minimized the heat transfer.

Similar results, in terms of heat transfer through the laminate stack were obtained with all of the wall configurations tested. However, in propagation tests with actual cells, there was a failure when using the 79% porous Al sheet. The jelly roll from a cell that was forced into thermal runaway using heat from a NiCr wire punctured the 79% porous Al sheet. Solid Al and steel sheets did not puncture in actual tests. A lower porosity Al sheet can be tested but has not completed our puncture testing to date. The difficulty is that we cannot simulate the puncture test until the actual test values are determined and they are extremely variable.

Combining these three wall component layers (namely the structural element, anisotropic material, and fire-resistant material) is unique in that in the event of a cell going into thermal runaway, it can prevent propagation to the opposing cell. Without this barrier a module will go into thermal runaway as found out through actual testing.

In destructive abuse tests, cylindrical cells were purposely caused to go into thermal runaway by either wrapping them in a NiCr wire and heating the cell beyond its safe level or by puncturing the cell with a nail. This cell was nested in the center of a seven cell sub-module. A second seven cell sub-module was setup with its headers facing the headers of the first sub-module to simulate the actual battery pack design. An important note is that (1) the bottoms of the cells were mounted to a metal cold plate and (2) cylindrical lithium-ion cells are designed to release gases through their headers. In some instances, the gases are ignited, and flames are emitted from the header. For maximum volumetric efficiency the headers in the cells in the battery modules are facing each other. In the first design tested that used only a single sheet of graphite foil, when the center cell of one of the sub-modules vented its internal jelly roll physically penetrated the sheet and ignited the opposing cell. The graphite foil sheet also shorted the top of some of the cells. This propagation cannot occur in a commercial product.

Based on the initial test results, this new physical barrier design was designed to prevent propagation of thermal runaway to the opposite sub-module. In addition to the graphite foil, a physical metal barrier and non-conductive 3M FRB™ sheet were added to prevent penetration and cell shorting, respectively.

This solution worked so well that in subsequent testing, despite temperatures exceeding >1000° C. on the side of the sub-module purposely put into thermal runaway, the opposite side of the physical barrier only reached ˜100° C. on its surface. This temperature itself is lower than the threshold for a lithium-ion cell to vent. A physical air gap between the physical barrier and the opposing cells reduces this temperature and prevents the opposing cells from experiencing a thermal runaway condition.

Another use of this barrier would be for a module case, primarily for pouch cells that can vent in multiple directions. Placing pouch cells inside a case made from the barrier wall would prevent flames or high temperature reaching the other modules. In this application, one would only need the structural element and one layer of graphite foil and one layer of FRB, on the inside of the module. One can also use this barrier as a case for other types of lithium-ion cells, including prismatic and cylindrical.

The exemplary systems and methods of this disclosure have been described in relation to a battery module 108 and a number of battery cells 308 in an electric vehicle energy storage system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others. In some embodiments, the present disclosure provides an electrical interconnection device that can be used between any electrical source and destination. While the present disclosure describes connections between battery modules and corresponding management systems, embodiments of the present disclosure should not be so limited.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a battery module, comprising: a housing comprising a base and sidewalls extending from a periphery of the base, the sidewalls and base defining a first containment cavity having a first volume, wherein the base comprises a plurality of receptacles formed therein, the plurality of receptacles arranged in a battery cell distribution pattern, wherein each receptacle in the plurality of receptacles is sized to receive a battery cell; an array of battery cells at least partially disposed within the first volume, the array of battery cells comprising base portions disposed in the plurality of receptacles of the housing and arranged in the battery cell distribution pattern providing an open volume surrounding each battery cell in the array of battery cells; and a structural adhesive disposed in the first volume of the housing and around each battery cell in the array of battery cells, the structural adhesive filling the open volume surrounding each battery cell mechanically coupling each battery cell in the array of battery cells together in a force distribution framework.

Aspects of the above battery module further comprise a cover comprising an upper surface and walls extending from a periphery of the upper surface, the walls and upper surface defining a second containment cavity having a second volume, wherein the cover is attached to the housing along at peripheral contacting surfaces of the walls and sidewalls, wherein upper portions of the array of battery cells are at least partially disposed in the second volume of the cover, wherein the upper portions of the array of battery cells are disposed opposite the base portions of the array of battery cells. Aspects of the above battery module include wherein the cover comprises a plurality of receptacles formed in the upper surface and arranged in the battery cell distribution pattern, wherein each receptacle in the plurality of receptacles formed in the upper surface is sized to receive a battery cell in the array of battery cells. Aspects of the above battery module include wherein the sidewalls of the housing include a flanged surface following at least a portion of the periphery of the base, the flanged surface offset from and substantially parallel to the base, wherein the walls of the cover include a mating flanged surface configured to mate with the flanged surface of the housing. Aspects of the above battery module include wherein the cover is temporarily attached to the housing via an adhesive layer disposed between the flanged surface of the sidewalls and the mating flanged surface of the cover, and wherein each battery cell in the array of battery cells is held in the battery cell distribution pattern via the plurality of receptacles formed in the base of the housing and the upper surface of the cover. Aspects of the above battery module include wherein the structural adhesive contacts surfaces of the sidewalls of the housing and the walls of the cover mechanically joining the housing, cover, and battery cells in the array of battery cells into a unified and integral structure. Aspects of the above battery module further comprise a battery cell retaining form comprising a substantially planar surface including an array of receptacles formed therethrough, the array of receptacles formed in the battery cell distribution pattern and configured to receive at least a portion of the array of battery cells. Aspects of the above battery module further comprise a dielectric fastening sleeve disposed between four adjacent battery cells in the array of battery cells, the dielectric fastening sleeve comprising a hollow shaft extending longitudinally from the upper surface of the cover through the base of the housing to a mount frame, the hollow shaft configured to receive an assembly fastener, wherein the battery module is fastened to a mount frame via the assembly fastener, and wherein a height of the hollow shaft defines a height of the battery module. Aspects of the above battery module include wherein a load or compressive force imparted by overtightening the assembly fastener is resisted by the dielectric fastening sleeve such that the housing and cover of the battery module do not substantially deform.

Embodiments include an energy storage device, comprising: a plurality of energy storage cells arranged in a number of spaced apart linear rows, wherein each energy storage cell in the plurality of storage cells is spaced apart from one another providing an open volume surrounding each energy storage cell; a carrier comprising a plurality of sidewalls and an upper and lower surface, the carrier including an internal void, wherein the plurality of energy storage cells are disposed at least partially within the internal void of the carrier; and a structural adhesive disposed in the internal void of the carrier, the structural adhesive filling the open volume surrounding each energy storage cell and at least a portion of the internal void of the carrier, the structural adhesive mechanically coupling each energy storage cell in the plurality of energy storage cells and the carrier together in a force distribution framework.

Aspects of the above energy storage device further comprise a cover forming the upper surface and a first portion of the plurality of sidewalls, wherein the first portion of the plurality of sidewalls extends from a periphery of the upper surface, the first portion of the plurality of sidewalls and upper surface defining a first volume of the internal void; and a housing forming the lower surface and a second portion of the plurality of sidewalls, wherein the second portion of the plurality of sidewalls extends from a periphery of the lower surface, the second portion of the plurality of sidewalls and upper surface defining a second volume of the internal void, wherein the first portion of the plurality of sidewalls are connected to the second portion of the plurality of sidewalls via mating flanged surfaces following at least a portion of the periphery of the carrier, the flanged surfaces offset from and substantially parallel to the upper and lower surfaces. Aspects of the above energy storage device further comprising an adhesive layer disposed between and in contact with the mating flanged surfaces of the first and second portions of the plurality of sidewalls. Aspects of the above energy storage device include wherein the structural adhesive contacts surfaces of the plurality of sidewalls in the internal void of the carrier and external surfaces of each energy storage cell in the plurality of energy storage cells mechanically joining the carrier and energy storage cells in the plurality of energy storage cells into a unified and integral structure. Aspects of the above energy storage device include wherein the energy storage devices are one or more of battery cells, capacitors, supercapacitors, and/or ultracapacitors. Aspects of the above energy storage device further comprising: a retaining form gasket comprising a substantially planar surface including receptacles arranged in the number of spaced apart linear rows and formed completely through the retaining form gasket, wherein each receptacle is sized to receive a portion of each energy storage cell in the plurality of energy storage cells in the energy storage device. Aspects of the above energy storage device include wherein the retaining form gasket maintains the plurality of energy storage cells in a position spaced apart from one another, wherein the retaining form gasket is disposed in the first volume of the internal void. Aspects of the above energy storage device further comprising: a nonconductive standoff disposed between four adjacent energy storage cells in the plurality of energy storage cells, the nonconductive standoff comprising a hollow shaft extending longitudinally from the upper surface of the carrier through the lower surface of the carrier to a surface of a mount frame, the hollow shaft receiving a fastener clamping the carrier and plurality of energy storage cells to the mount frame, wherein a height of the hollow shaft defines a height of the energy storage device, wherein the structural adhesive contacts a surface of the nonconductive standoff mechanically joining the nonconductive standoff in the unified and integral structure of the energy storage device.

Embodiments include a battery for an electric vehicle, comprising: a plurality of battery modules electrically interconnected with one another, wherein each battery module of the plurality of battery modules comprises: a housing comprising a base and sidewalls extending from a periphery of the base, the sidewalls and base defining a first containment cavity having a first volume, wherein the base comprises a plurality of receptacles formed therein, the plurality of receptacles arranged in a battery cell distribution pattern, wherein each receptacle in the plurality of receptacles is sized to receive a battery cell; an array of battery cells at least partially disposed within the first volume, the array of battery cells comprising base portions disposed in the plurality of receptacles of the housing and arranged in the battery cell distribution pattern providing an open volume surrounding each battery cell in the array of battery cells; and a structural adhesive disposed in the first volume of the housing and around each battery cell in the array of battery cells, the structural adhesive filling the open volume surrounding each battery cell mechanically coupling each battery cell in the array of battery cells together in a force distribution framework.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A fire propagation prevention apparatus for a battery pack including one or more battery modules, the one or more battery modules comprising a plurality of battery cells arranged in a plurality of rows, wherein each battery cell in the one or more battery modules comprises a vent, the apparatus comprising:
a structural element separating at least two of the battery modules of the plurality of battery modules; and
a thermally anisotropic material positioned between the structural element and one or more of the at least two of the battery modules and in thermal contact with one or more battery cells of the one or more of the at least two of the battery modules, wherein the thermally anisotropic material has an in-plane thermal conductivity greater than a through-plane thermal conductivity.

2. The apparatus of claim 1, wherein the thermally anisotropic material is made of natural graphite or synthetic graphite and wherein the thermally anisotropic material has at least an in-plane thermal conductivity of about 250 W/m-K and at least a through plane thermal conductivity of about 2.5 W/m-K.

3. The apparatus of claim 1, wherein the headers of each battery cell in the at least two battery modules are oriented in the direction of the structural element.

4. The apparatus of claim 1, further comprising a sensor in thermal in thermal contact with one or more battery cells of the one of more battery modules, wherein the sensor is configured to sense thermal energy transferred by one of more of the battery cells to the thermally anisotropic material, and wherein the sensor is at least a temperature sensor.

5. The apparatus of claim 1, further comprises a fire resistant material, wherein the fire-resistant material is non-conductive and can resist fires ranging from about 700-1100° C., and wherein the fire resistant material is positioned over the thermally anisotropic material.

6. The apparatus of claim 1, wherein the ratio of the in-plane thermal conductivity to the through plane thermal conductivity of the thermally anisotropic material is at least about 66.

7. The apparatus of claim 1, wherein the structural element is made of a puncture resistant material.

8. A method for fire propagation prevention in a battery pack including one or more battery modules, the one or more battery modules comprising a plurality of battery cells arranged in a plurality of rows, wherein each battery cell in the one or more battery modules comprises a vent, the method comprising:
venting, by at least one battery cell of the plurality of battery cells, of thermal energy; and
transferring, by a thermally anisotropic material, heat away from the venting at least one battery cell of the plurality of battery cells.

9. The method of claim 8, further comprising:
ejecting fire from the vented battery cell of the plurality of battery cells; and
stopping the ejection trajectory and spread of fire from the vented battery cell of the plurality of battery cells.

10. The method of claim 9, further comprising:
ejecting the vented at least one battery cell of the plurality of battery cells internal components; and
stopping the ejection trajectory of the internal components from the vented at least one battery cell of the plurality of battery cells.

11. The method of claim 8, further comprising:
sensing, via at least one sensor, heat vented by at least one battery cell of the plurality of battery cells.

12. The method of claim 10, further comprising:
preventing at least one of heat, fire, or projectiles from causing a different battery cell in a different battery module to vent.

13. A fire propagation prevention system for an electric vehicle system, comprising:
one or more battery modules, wherein the one or more battery modules comprises a plurality of battery cells arranged in a plurality of rows and a battery module enclosure for the one or more battery modules, wherein each of the plurality of battery cells comprises a vent;
a structural element separating at least two battery modules of the at least one or more battery modules; and
a fire-resistant material, wherein the fire-resistant material is substantially electrically non-conductive and/or insulative and wherein the fire-resistant material is positioned between the structural element and the at least two battery modules.

14. The system of claim 13, wherein the headers of each battery cell in the at least two battery modules are oriented in the direction of the structural element.

15. The system of claim 13, further comprises a thermally anisotropic material positioned over the structural element and in thermal contact with plurality of battery cells, and wherein the thermally anisotropic material has an in-plane thermal conductivity greater than a through-plane thermal conductivity, the thermally anisotropic material being positioned between the fire resistant material and the structural element.

16. The system of claim 15, wherein the thermally anisotropic material is made of natural graphite or synthetic graphite, wherein the thermally anisotropic material has at least an in-plane thermal conductivity of about 250 W/m-K and at least a through plane thermal conductivity of about 2.5 W/m-K, and wherein the ratio of the in-plane thermal conductivity to the through plane thermal conductivity of the thermally anisotropic material is at approximately 66.

17. The system of claim 13, wherein the structural element separates the battery module and at least one additional battery module, wherein the least one additional battery module comprises a second plurality of battery cells arranged in a plurality of rows and a battery module enclosure for the least one additional battery module, wherein each battery cell in the second plurality of battery cells comprises a vent, wherein the headers of each battery cell in the at least two battery modules are oriented in the direction of the wall structure.

18. The system of claim 13, further comprises:
a thermally anisotropic material positioned over the structural element and in thermal contact with the plurality of battery cells, wherein the thermally anisotropic material has an in-plane thermal conductivity greater than a through-plane thermal conductivity; and
a sensor in operational contact with the thermally anisotropic material, wherein the thermally anisotropic material is in thermal contact with the plurality of battery cells, wherein the sensor is configured to sense thermal energy transferred by one or more of the battery cells in the plurality of battery cells to the thermally anisotropic material, and wherein the sensor is at least a temperature sensor.

19. The system of claim 13, further comprises the fire-resistant material, wherein the fire resistant material is non-conductive and can resist fires ranging from about 700-1100° C.

20. The system of claim 15, wherein the structural element is made of a puncture resistant material.
